(19) United States
(12) Patent Application Publication
(10) Pub. No.: US 2011/0031074 A1
(43) Pub. Date: Feb. 10, 2011

(54) ELECTRIC MOTOR-DRIVEN BRAKE APPARATUS

(76) Inventor: Hideaki ISHII, Minami Alps-shi (JP)

Correspondence Address: WENDEROTH, LIND & PONACK, L.L.P., 1030 15th Street, N.W.,, Suite 400 East, Washington, DC, 20005-1503, US

(21) Appl. No.: 12/844,169

(22) Filed: Jul. 27, 2010

(30) Foreign Application Priority Data
Jul. 31, 2009 (JP) 180162/2009

(51) Int. Cl. F16D 65/35

(52) U.S. Cl. 188/156

(57) ABSTRACT

An input rod and an input piston are advanced in response to an operation of a brake pedal, and an electric motor is driven according to the movement of the input piston to propel a primary piston in a master cylinder through a ball-screw mechanism. Thus, a hydraulic pressure is generated and supplied to a brake caliper of each wheel. At this time, a part of the hydraulic pressure is received by the input piston, and a part of the reaction force of hydraulic pressure during braking is fed back to the brake pedal. A nut member of the ball-screw mechanism has a nut part with a ball groove and a rotor part thinner in wall thickness than the nut part. A rotor core of the electric motor is press-fitted to the rotor part, thereby making it difficult for stress produced in the rotor part by press fitting to be transmitted to the nut part, and maintaining the high dimensional accuracy of the ball groove on the nut part.

### BACKGROUND OF THE INVENTION

The present invention relates to an electric motor-driven brake apparatus for use in an automotive brake system.

Among brake apparatus for use in automotive brake systems, there is known an electric motor-driven booster using an electric motor as a boost source, as disclosed, for example, in Japanese Patent Application Publication No. 2008-302725. In the electric motor-driven booster, the electric motor is driven according to a driving command based on an operation of a brake pedal or the like, and the rotation of the rotor of the motor is converted into a rectilinear motion through a ball-screw mechanism, which is a rotation-rectilinear motion conversion mechanism. The rectilinear motion is transmitted to an output member to generate braking force.

In the electric motor-driven booster disclosed in Japanese Patent Application Publication No. 2008-302725, which is one type of electric motor-driven brake apparatus, a nut member serving as a rotating member of the ball-screw mechanism is inserted into the inner peripheral portion of the rotor of the electric motor, and the rotor and the nut member are secured to each other so as to rotate together as one unit. In this structure, the rotor of the motor and the nut member of the ball-screw mechanism are connected to each other as stated above, and a stator is disposed at the outer periphery of the rotor to generate a rotating magnetic field. Such a structure is likely to become complicated and desired to be simplified.

### SUMMARY OF THE INVENTION

An object of the present invention is to provide a structure suitable for simplification of an electric motor-driven brake apparatus in which a rotation-rectilinear motion conversion mechanism, typically represented by the above-described ball-screw mechanism, is disposed inside a rotor of an electric motor. Embodiments described below have attained the object of the present invention and solved the above-described technical problem and other problems desired to be solved for electric motor-driven brake apparatus as manufactured articles. These will be explained below.

To solve the above-described problem, the present invention provides an electric motor-driven brake apparatus in which the rotation of an electric motor is converted into a rectilinear motion through a rotation-rectilinear motion conversion mechanism to generate braking force. The rotation-rectilinear motion conversion mechanism has a nut member driven to rotate by a rotor of the electric motor and a screw shaft disposed at the inner periphery of the nut member and moved rectilinearly by the rotation of the nut member. The nut member has a nut part engaged with the screw shaft and a rotor part axially extending from the nut part. The rotor of the electric motor is disposed at the rotor part of the rotation-rectilinear motion conversion mechanism. Thus, the present invention provides a structure suitable for simplification of electric motor-driven brake apparatus.

### BRIEF DESCRIPTION OF THE DRAWINGS

FIG. 1 is a longitudinal sectional view of an electric motor-driven booster as an electric motor-driven brake apparatus according to one embodiment of the present invention.

FIG. 2 is an enlarged view of a main part of the electric motor-driven brake apparatus shown in FIG. 1.

FIG. 3 is a conceptual sectional view of an electric motor of the electric motor-driven brake apparatus taken along a plane perpendicular to the axis of rotation of the motor.

FIG. 4 is an enlarged view of a part of a rotor of the electric motor.

FIG. 5 is a view of a rotor of an electric motor-driven brake apparatus according to another embodiment of the present invention.

### DETAILED DESCRIPTION OF THE INVENTION

Embodiments of the present invention explained below have attained the object of the present invention and solved the above-described technical problem and many other problems desired to be solved for electric motor-driven brake apparatus as manufactured articles. Some of these will be explained below. According to the following embodiments, the rotor of the electric motor is secured to the nut member at a position axially away from the nut part. Accordingly, it is possible to reduce the influence of stress resulting from securing the rotor to the nut member. Particularly, when a ball-screw mechanism is used as a rotation-rectilinear motion conversion mechanism, it is likely to be influenced by the stress. In this regard, the above-described structure can suppress the influence of stress on the mechanism to a minimum.

Because the rotor of the electric motor uses an interior permanent magnet structure, the magnetic reluctance between the stator and rotor of the motor can be reduced, which leads to an improvement in efficiency. Particularly, because the magnets are secured in magnet insertion holes formed in the rotor, the gap between the stator core and the rotor core can be reduced, and hence the magnetic reluctance can be reduced.

Because of the structure in which an auxiliary magnetic pole is formed between each pair of mutually adjacent magnetic poles of the rotor to utilize reluctance torque, it is easy to maintain the supply of electric current to the electric motor even when the supply voltage drops. Thus, safety can be further improved.

Because the number of magnetic poles of the rotor is not less than 6, particularly 8 in the embodiments, d- and q-axis magnetic circuits can be formed at positions radially closer to the outer periphery of the rotor core. Accordingly, the efficiency reduction is small even if a hole is formed in the center of the rotor core, and the center of the rotor core can be used for other purposes. In addition, because d- and q-axis magnetic fluxes passing through the center of the rotor core can be reduced, even if non-laminated metal structures such as the rotor of the ball-screw mechanism and the cylinder mechanism are disposed in the center of the rotor core, the induced eddy current is small. In addition, the heat generation by eddy current can be reduced.

One embodiment of the present invention will be explained below in derail with reference to the accompanying drawings.

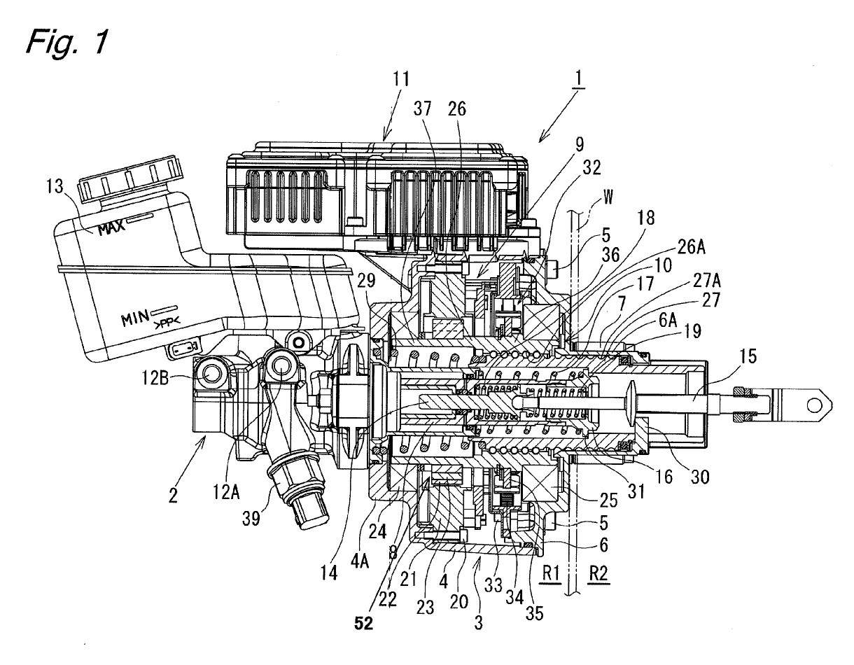

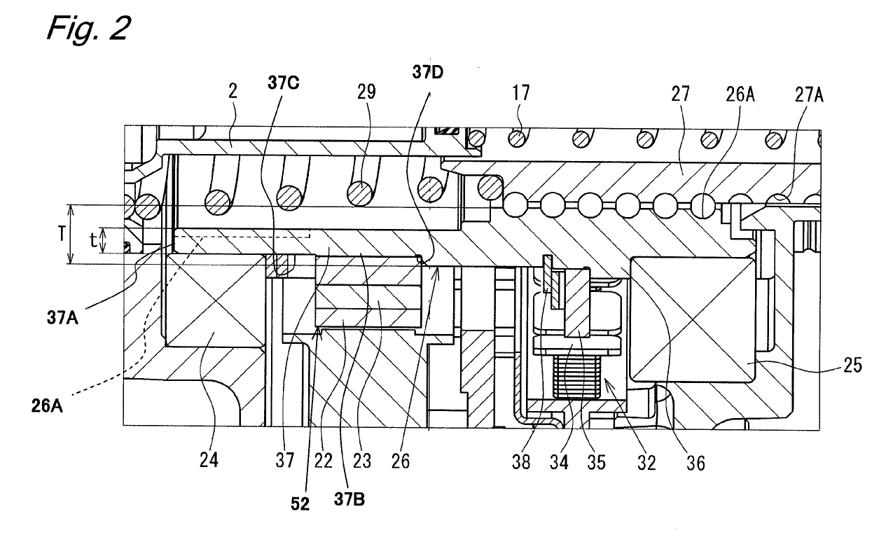

FIG. 1 shows the general view of an electric motor-driven booster 1 as an electric motor-driven brake apparatus according to a first embodiment of the present invention. FIG. 2 is an enlarged view of a main part of the electric motor-driven booster 1. As shown in FIGS. 1 and 2, the electric motor-driven booster 1 has a casing 3. The casing 3 has one end and the other end. The one end of the casing 3 is secured to a partition W partitioning between an engine room R1 and compartment R2 of a vehicle. A tandem master cylinder 2 is connected to the other end of the casing 3. In the following description, the engine room R1 side is defined as front side, and the compartment R2 side as rear side, for the sake of explanation.

The casing 3 has a tubular casing body 4 and a rear cover 6 attached to the rear end of the casing body 4 with bolts 5. The casing body 4 has a stepped front wall 4A integrally formed therewith at the front end thereof. The master cylinder 2 is secured to the front wall 4A. The rear cover 6 is provided with a plurality of stud bolts 7, with which the casing 3 is attached to the partition W of the vehicle. The rear cover 6 has a circular cylindrical portion 6A integrally formed therewith to project rearward. The cylindrical portion 6A extends through the partition W into the compartment R2. The casing 3 contains an electric motor 9 and a ball-screw mechanism 10 operating as a rotation-rectilinear motion conversion mechanism, together with a primary piston 8. With the primary piston 8 incorporated in the casing 3, the rear end of the master cylinder 2 is attached to the casing 3 from the front side. In addition, a controller 11 for driving the motor 9 is attached to the top of the casing 3.

The master cylinder 2 is a tandem master cylinder, which has a primary piston 8 and a secondary piston (not shown). The advance of these pistons causes hydraulic pressure to be supplied to the hydraulic pressure passages of two hydraulic pressure systems from hydraulic pressure ports 12A and 12B. In response to the operation of the primary piston 8 and the secondary piston, the master cylinder 2 is appropriately replenished with brake fluid from a reservoir 13 attached to the top of the master cylinder 2. If the hydraulic pressure circuit of one of the two hydraulic pressure systems should fail, the supply of hydraulic pressure to the other hydraulic pressure system can be maintained to ensure the required braking force.

The primary piston 8 has an input piston 14 slidably and fluid-tightly fitted through an intermediate wall thereof. The rear end of the input piston 14 is provided with a connecting portion to which the distal end of an input rod 15 is connected. The input rod 15 is inserted in the cylindrical portion 6A of the rear cover 6 and the rear part of the primary piston 8. The rear end portion of the input rod 15 extends from the cylindrical portion 6A into the compartment R2, and a brake pedal (not shown) is connected to the rear end of the input rod 15. A flange-shaped spring retainer 16 is attached to the rear end of the primary piston 8. The primary piston 8 is urged in a retracting direction by a return spring 17, which is a compression coil spring, interposed between the spring retainer 16 and the rear end of the master cylinder 2. The input piston 14 is resiliently held in a neutral position relative to the primary piston 8 shown in FIG. 1 by springs 18 and 19. The spring 18 is interposed between the connecting portion provided at the rear end of the input piston 14 and the intermediate wall of the primary piston 8. The spring 19 is interposed between the connecting portion of the input piston 14 and the spring retainer 16.

The electric motor 9 is an interior permanent magnet synchronous motor, which has a stator 21 and a rotor 52. The stator 21 has a plurality of coils which are secured to a step of the rear side of the front wall 4A of the casing body 4 with bolts 20. The rotor 52 includes a circular cylindrical rotor core 22 disposed to face the inner peripheral surface of the stator 21 and a plurality of permanent magnets 23 inserted in the rotor core 22. In this embodiment, 8 permanent magnets 23 are arranged to form 8 magnetic poles.

The ball-screw mechanism 10 has a circular cylindrical nut member 26, a circular cylindrical screw shaft 27 serving as a rectilinear motion member, and a plurality of balls as rolling elements.

The cylindrical nut member 26 is rotatably supported to the casing 3 by bearings 24 and 25.

The cylindrical screw shaft 27 is inserted in the nut member 26 and the cylindrical portion 6A of the rear cover 6.

The balls as rolling elements are loaded between ball grooves 26A and 27A formed on the mutually opposing surfaces of the nut member 26 and the screw shaft 27.

The screw shaft 27 has an axially extending slit formed in the rear end portion thereof, and a stopper 30 at the rear end of the cylindrical portion 6A of the rear cover 6 is fitted in the slit. Thus, the screw shaft 27 is supported to be axially movable but nonrotatable about the axis. Rotation of the nut member 26 causes the balls to roll along the ball grooves 26A and 27A, thereby allowing the screw shaft 27 to move in the axial direction. The nut member 26 has the rotor core 22 of the electric motor 9 secured thereto by press fitting to rotate together with the rotor 52 as one unit.

The screw shaft 27 is urged in a retracting direction by a return spring 29, which is a tapered compression coil spring. The return spring 29 is interposed between the screw shaft 27 and the front wall 4A of the casing body 4. The retract position of the screw shaft 27 is limited by the stopper 30 provided on the cylindrical portion 6A of the rear cover 6. The screw shaft 27 has the rear end portion of the primary piston 8 inserted therein. The retract position of the primary piston 8 is limited by abutment of the spring retainer 16 against a stepped portion 31 formed on the inner periphery of the screw shaft 27. Thus, the primary piston 8 can advance together with the screw shaft 27 and can also advance solely away from the stepped portion 31.

The casing body 4 is provided therein with the rotor core 22 and a resolver 32 detecting the rotational position of the nut member 26. The resolver 32 comprises a resolver stator 34 attached to the rear cover 6 with bolts 33 and a resolver rotor 35 attached to the outer periphery of the rotor member 26 to face the inner periphery of the resolver stator 34.

Next, the nut member 26 of the ball-screw mechanism 10 will be explained in more detail with reference mainly to FIG. 2.

As shown in FIG. 2, the nut member 26 extends axially, in the casing 3, from near the end of the front wall 4A of the casing body 4 to near the end of the rear wall of the rear cover 6. The nut member 26 comprises a nut part 36 provided at the rear side and having the ball groove 26A, and a rotor part 37 extending axially forward from the nut part 36. The rotor part 37 has the rotor core 22 press-fitted thereto, thereby the rotor core 22 being secured to the nut member 26. A region of the rotor part 37 to which the rotor core 22 is press-fitted is provided with a step 37B slightly higher than the end portion 37A of the rotor part 37. The rotor part 37 has a small-diameter portion 37C between the step 37B and the end portion 37A. The small-diameter portion 37C between the step 37B and the end portion 37A reduces insertion resistance encountered when the rotor core 22 is press-fitted. The rotor part 37 has a stepped portion at a region adjacent to the nut part 36. The stepped portion is formed with a small annular groove 37D. The annular groove 37D relaxes fastening stress applied to the nut member 26 from the rotor core 22. The wall thickness t of the rotor part 37 is thinner than the wall thickness T of the nut part 36. With this structure, when the rotor core 22 is press-fitted to the rotor part 37, strain stress produced in the rotor part 37 by the fitting process is unlikely to be transmitted to the nut part 36 having the ball groove 26A. The nut member 26 is supported by a bearing 24. The bearing 24 is provided adjacently to the front wall 4A of the casing body 4. The rear end portion of the nut part 36 is supported by a bearing 25 provided on a stepped portion of the rear cover 6. The nut member 26 is rotatably supported to the casing 3 by the bearings 24 and 25. The resolver rotor 35 is attached to the outer periphery of the nut part 36 with a retaining ring 38. The resolver rotor 35 may be attached by press fitting or bonding, for example. In such a case, it is desirable to take into account the influence of press fitting or bonding on the nut part 36 and hence the ball groove 26A, for example, the influence of strain stress caused by press fitting.

It should be noted that the nut member 26 may be provided with a thin walled region between the rotor part 37 and the nut part 36 to reduce the sectional area of the region between the rotor and nut parts 37 and 36. In this case, strain stress is concentrated in the region between the rotor and nut parts 37 and 36; therefore, strain stress produced in the rotor part 37 by press fitting of the rotor core 22 becomes unlikely to be transmitted to the nut part 36. In addition, the inner peripheral surface of the rotor part 37 may be tapered along the return spring 29.

The controller 11 controls the rotation of the electric motor 9 on the basis of detection signals from various sensors including a displacement sensor (not shown) detecting the displacement of the input rod 15, the resolver 32, and a hydraulic pressure sensor 39 detecting the hydraulic pressure in the master cylinder 2.

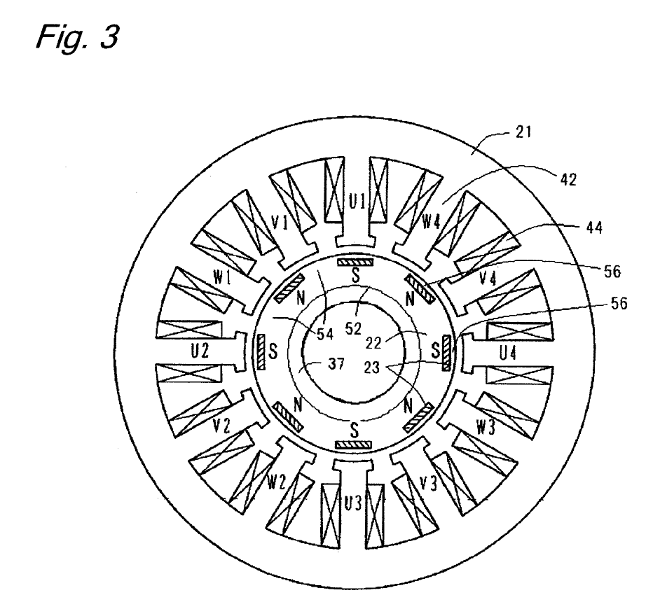

FIG. 3 is a conceptual sectional view of the electric motor 9 taken along a plane perpendicular to the axis of rotation of the motor 9. Stator windings 44 is wound around teeth 42 of the stator 42 by the concentrated winding method. The teeth 42 of the stator 21, which are stator cores, are made of electromagnetic steel sheets stacked in a direction along the axis of rotation with a view to reducing eddy current. At the radially inner side of the teeth 42 of the stator 21, the rotor 52 is secured to the rotor part 37 of the nut member 26 with an air gap interposed between the rotor 52 and the teeth 42. Examples of methods of securing the rotor 52 to the nut member 26 include a method in which the rotor 52 is press-fitted to the rotor part 37 of the nut member 26, and a method in which a key is inserted between the rotor 52 and the rotor part 37 of the nut member 26. In this embodiment, the rotor 52 is press-fitted to the outer periphery of the rotor part 37 of the nut member 26, thereby securing the rotor 52 to the nut member 26.

The rotor 52 has a rotor core 22 and 8 permanent magnets 23 inserted in the rotor core 22 to form 8 magnetic poles. The rotor core 22 is made of magnetic steel sheets stacked in a direction along the axis of rotation. By using stacked magnetic steel sheets to form the rotor core 22, eddy current can be reduced. The rotor core 22 is formed with circumferentially equally spaced magnet insertion holes 22A extending in a direction along the axis of rotation. The magnet insertion holes 22A may be formed at a plurality of positions. In this embodiment, the magnet insertion holes 22A are formed at 8 positions. One permanent magnet 23 is inserted into each of the magnet insertion holes 22A.

It should be noted that, in the actual process of manufacturing the rotor 52, magnetic members made of an unmagnetized magnetic material, e.g. neodymium or ferrite, are inserted into the magnet insertion holes 22A of the rotor core 22, and after the insertion process, strong magnetic flux is externally supplied to the magnetic members, thereby magnetizing the magnetic members to form permanent magnets 23. The reason for this is as follows. If the magnetic members are magnetized to form permanent magnets 23 before they are inserted into the rotor core 22, it becomes difficult to insert the permanent magnets 23, which are strong magnets, into the magnet insertion holes 22A of the rotor core 22 because strong magnetic attractive force acts between the permanent magnets 23 and the rotor core 22, which would result in a reduction in productivity. In addition, if the magnetic members are magnetized to form permanent magnets 23 before they are inserted into the rotor core 22, the permanent magnets 23 may attract iron powder and magnetic powder during manufacturing. The contaminants thus attached to the permanent magnets 23 may make it difficult to insert the permanent magnets 23 into the magnet insertion holes 22A. Regarding the magnetization direction of each permanent magnet 23, if one permanent magnet 23 is magnetized such that its stator side is a north pole and its side closer to the center of the rotor is a south pole, a permanent magnet 23 adjacent to it is magnetized in the opposite direction, i.e. such that its stator side is a south pole and its side closer to the center of the rotor is a north pole. That is, each pair of mutually adjacent magnetic poles are magnetized in opposite directions.

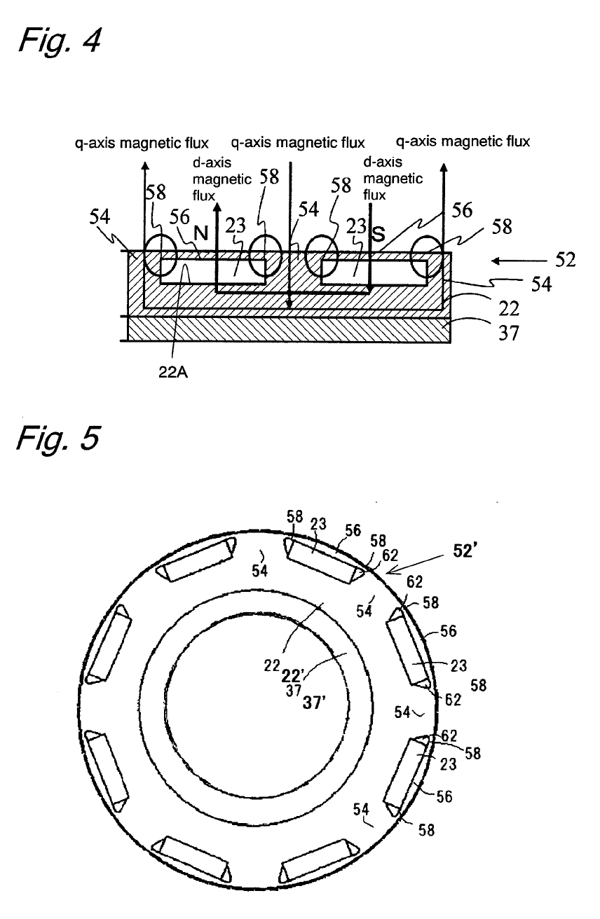

Each permanent magnet 23 forms a magnetic pole of the rotor 52. As shown in FIG. 4, d-axis magnetic flux generated in each permanent magnet 23 is guided to the stator 21 from a pole piece 56. The pole piece 56 is formed between the permanent magnet 23 and the teeth 42-side surface of the rotor core 22. Magnet torque, which is first rotating torque, is generated based on the d-axis magnetic flux and a rotating magnetic field that the stator windings 44 produce.

Meanwhile, the rotating magnetic field formed by the stator windings 44 produces q-axis magnetic flux passing through an auxiliary magnetic pole 54 formed between each pair of mutually adjacent magnetic poles of the rotor core 22. Reluctance torque, which is second rotating torque, is generated based on the difference between the reluctance of a magnetic circuit produced by the rotating magnetic field to pass through the auxiliary magnetic pole 54 and the reluctance of a magnetic circuit passing through the permanent magnet 23. Torque generated by the electric motor 9 is a total of the magnet torque and the reluctance torque.

It should be noted that torque reduction during high-speed rotation can be reduced by increasing the above-described reluctance torque. In addition, increasing the reluctance torque can reduce the amount of permanent magnets 23 and hence can reduce the amount of use of the magnet material made of precious rare metal, which leads to a cost reduction. The torque generated by the electric motor 9 on the basis of the supplied electric power is a total of the magnet torque and the reluctance torque. Therefore, if the proportion of the magnet torque is reduced, it is possible to reduce the amount of permanent magnets 23, i.e. the amount of magnetic flux that the permanent magnets 23 generate. The magnetic flux produced by the permanent magnets 23 generates an internally-induced voltage. Accordingly, as the rotational speed of the electric motor 9 increases, the internally-induced voltage increases.

On the other hand, the current flowing into the electric motor 9 is based on the difference between the supply voltage and the internally-induced voltage. Accordingly, as the rotational speed of the electric motor 9 increases, the current that can be supplied to the electric motor 9 reduces, and the torque generated during high-speed rotation reduces. From the above-described point of view, in the electric motor 9 of this embodiment, an auxiliary magnetic pole 54 is formed between each pair of mutually adjacent magnetic poles to utilize the reluctance torque. Therefore, it is possible to suppress the internally-induced voltage during high-speed rotation and hence possible to increase the supply of current to the electric motor 9.

In this embodiment, the controller 11 operates on electric power supplied from a battery mounted on the vehicle, which is a low-voltage power source, e.g. 14 volt power source. The low-voltage power source also supplies electric power to other electric loads, e.g. headlights or an air conditioner-driving motor. Therefore, the supply voltage of the battery may drop under the influence of other electric loads. It is desirable, in order to perform braking force control with high reliability under such conditions, to suppress the rise of internally-induced voltage of the electric motor 9. From this viewpoint also, the electric motor 9 of this embodiment has a structure in which auxiliary magnetic poles 54 are formed to generate reluctance torque, and therefore can cope with the above-described problem. That is, it is possible to perform braking force control with high reliability even when the supply voltage of the battery drops under the influence of other electric loads.

FIG. 4 is a fragmentary enlarged view showing the north and south magnetic poles of the permanent magnets 23 and the auxiliary magnetic poles 54 therebetween, which are shown in FIG. 3.

A permanent magnet 23 (left-hand permanent magnet as seen in FIG. 4) whose stator 21 side is a north pole supplies d-axis magnetic flux to the stator 21 through a pole piece 56. On the other hand, the stator 21 supplies d-axis magnetic flux through a pole piece 56 to a permanent magnet 23 (right-hand permanent magnet as seen in FIG. 4) whose stator 21 side is a south pole. The d-axis magnetic flux generates the above-described magnet torque.

In addition, the stator 21 supplies q-axis magnetic flux to one auxiliary magnetic pole 54. The q-axis magnetic flux returns to the stator 21 from other auxiliary magnetic poles 54. Reluctance torque is generated based on the q-axis magnetic flux.

In the rotor 52 of this embodiment, bridge portions 58 are provided between the pole pieces 56 and the auxiliary magnetic poles 54, respectively, i.e. at regions enclosed by circles in FIG. 4, to reduce leakage magnetic flux between the pole pieces 56 and the auxiliary magnetic poles 54. That is, a bridge portion 58 having a small cross-sectional area of magnetic passage is formed between each magnet end and the stator 21-side end surface of the rotor core 22, thereby generating magnetic saturation to converge the flow of magnetic flux passing through the bridge portion 58. With this structure of the rotor 52, the efficiency of the electric motor 9 can be improved.

In this embodiment, the number of magnetic poles of the rotor 52 is not less than 6, i.e. 8. By thus increasing the number of magnetic poles, magnetic circuits through which the above-described d- and q-axis magnetic fluxes pass can be formed in the rotor core 22 near the permanent magnets 23 at the sides thereof closer to the center of the rotor core 22. In other words, the magnetic circuits can be formed radially near the permanent magnets 23, not near the center of the rotor core 22. Accordingly, it is possible to reduce the efficiency degradation caused by the increase of the air gap at the center of the rotor core 22. If magnetic flux enters the rotor part 37 from the rotor core 22 near the center of the rotor core 22, an eddy current is generated because the rotor part 37 is not a laminate structure, resulting in a reduction in efficiency and a rise in temperature. In this regard, by increasing the number of magnetic poles of the rotor 52 to not less than 6 as stated above, the magnetic circuits of magnetic fluxes passing through the rotor core 22 at the sides of the permanent magnets 23 closer to the center of the rotor core 22 can be formed near the permanent magnets 23, and the magnetic flux passing through the rotor part 37 can be reduced. It should, however, be noted that increasing the number of magnetic poles causes the structure to become complicated and thus degrades the productivity. In view of this, it is desirable that the number of magnetic poles of the rotor 52 be not more than 16.

The following is an explanation of the operation of this embodiment arranged as stated above.

When the brake pedal is actuated, the input rod 15 is moved to advance the input piston 14. The controller 11 controls the operation of the electric motor 9 on the basis of the displacement of the input rod 15 detected by the displacement sensor, thus causing the primary piston 8 to advance through the ball-screw mechanism 10 following the displacement of the input rod 15. As a result, a hydraulic pressure is generated in the master cylinder 2, and this hydraulic pressure is supplied to the brake caliper of each wheel through the hydraulic pressure ports 12A and 12B to generate braking force.

At this time, a part of the hydraulic pressure generated in the master cylinder 2 is received by the input piston 14, and the reaction force of the input piston 14 is fed back to the brake pedal through the input rod 15. Thus, a desired braking force can be generated with a predetermined boost ratio. The controller 11 properly controls the following position of the primary piston 8 relative to the input piston 14 such that the spring forces of the springs 18 and 19 acts on the input piston 14, thereby adjusting the reaction force to the input rod 15. Thus, it is possible to obtain a brake pedal reaction force suitable for use during automatic brake control, such as boost control, brake assist control, vehicle stability control, inter-vehicle control, regenerative cooperative control, etc.

Next, the assembly process of the electric motor-driven booster 1 will be explained.

One bearing 24 and the stator 21 of the electric motor 9 are attached to the casing body 4, and the other bearing 25 and the resolver stator 34 are attached to the rear cover 6.

The rotor core 22 and the resolver rotor 35 are attached to the nut member 26 of the ball-screw mechanism 10 assembled from the nut member 26, the screw shaft 27 and the balls.

The ball-screw mechanism 10 is assembled to the casing body 4, and the rear cover 6 is connected to the casing body 4 with the bolts 5.

Further, the controller 11 is attached to the top of the casing body 4, and the stator 21 and the resolver stator 34 are electrically connected to a control board (not shown) of the controller 11 by using busbars (not shown).

In this state, the electric motor 9 can be operated to drive the ball-screw mechanism 10 and to operate the resolver 32 by supplying electric power to the controller 11. Accordingly, it is possible to inspect the operating conditions of the electric motor 9, the ball-screw mechanism 10 and the resolver 32. If the inner peripheral surface of the rotor part 37 of the nut member 26 is formed with a recess-projection configuration (shown by the dotted line in FIG. 2), e.g. an axially extending key groove 26A or spline, a detecting element of an inspecting device may be fitted to the recess-projection configuration, whereby the rotational movement (torque, speed, etc.) of the nut member 26 can be easily measured, and the operation of the electric motor 9 can be inspected.

After the primary piston 8, the input piston 14, the input rod 15 and so forth have been installed in the casing 3, the master cylinder 2 is attached to the casing 3 from the front side. In this way, the electric motor-driven booster 1 can be assembled.

In this embodiment, the nut member 26 of the ball-screw mechanism 10 and the rotor core 22 of the electric motor 9 are connected by press fitting. Accordingly, the structure is simple, and the number of component parts used can be reduced. The rotor part 37 to which the rotor core 22 is press-fitted is axially away from the nut part 36 formed with the ball groove 26A and is thinner in wall thickness than the nut part 36. Accordingly, strain stress produced in the rotor part 37 by press fitting of the rotor core 22 is unlikely to be transmitted to the nut part 36. Thus, it is possible to suppress deformation of the nut part 36 and to maintain the dimensional accuracy of the ball groove 26A.

In this embodiment, because the electric motor 9 is a high-efficiency interior permanent magnet synchronous motor, the power consumption can be reduced. The electric motor 9, however, may be a synchronous motor having permanent magnets disposed on the surface of a rotor core, or other types of motors, e.g. an induction motor.

It should be noted that the structure in which the rotor part 37 is axially away from the nut part 36 is also useful in a case where the rotor core 22 is attached to the rotor part 37 by a method other than press fitting (e.g. bonding). That is, in a case where the rotor part 37 and the nut part 36 are not axially away from each other, the following problems may arise. For example, if the above-described process is adopted in which the permanent magnets 23 are formed by magnetizing the magnetic members after they have been inserted into the rotor core 22, the nut part 36 and the balls may be unnecessarily magnetized. In a case where the rotor core 22 is bonded to the rotor part 37, if a thermosetting adhesive is employed, heating used for bonding may affect lubricating grease applied to the nut part 36 of the ball-screw mechanism 10. Thus, the structure of this embodiment in which the rotor part 37 is axially away from the nut part 36 suppresses the likelihood that the nut part 36 and the balls of the ball-screw mechanism 10 may be unnecessarily magnetized. Consequently, the ball-screw mechanism 10 operates smoothly, and the reliability of the electric motor-driven booster improves. In addition, the likelihood that the heating process may affect the lubricating grease in the ball-screw mechanism 10 is suppressed. Thus, the ball-screw mechanism 10 operates smoothly, and the reliability of the electric motor-driven booster improves.

FIG. 5 is a sectional view showing a rotor 52′ and rotor part 37′ of an electric motor-driven booster 1′ according to a second embodiment of the present invention. The second embodiment differs from the first embodiment shown in FIGS. 3 and 4 in that magnetic air gaps 62 are formed at both sides of each magnet insertion hole. That is, a magnetic air gap 62 is formed between each permanent magnet 23 for forming a magnetic pole and an auxiliary magnetic pole 54 adjacent thereto, whereby cogging torque can be reduced, and the rotation becomes smooth. In addition, a magnetic bridge 58 can be formed between each magnetic air gap 62 and the stator 21-side surface of the rotor core 22′, which leads to a reduction of leakage magnetic flux and also leads to an efficiency improvement. The structure shown in FIG. 5 can be expected to have advantageous effects similar to those described in the first embodiment shown in FIGS. 3 and 4. Because the number of magnetic poles is not less than 6, i.e. 8, the magnetic circuits through which the d- and q-axis magnetic fluxes pass can be formed at respective positions not very far from the center-side surfaces of the permanent magnets 23, and hence the hole in the center-side of the rotor core 22′ can be enlarged.

Although in the foregoing embodiments the technical significance of the present invention has been described by using an electric motor-driven booster, the present invention is not limited to the electric motor-driven booster but may also be applied to other electric motor-driven brake apparatus, for example, an electric motor-driven disk brake in which a friction pad is pressed against a disk by an electric motor.

Although only some exemplary embodiments of this invention have been described in detail above, those skilled in the art will readily appreciate that many modifications are possible in the exemplary embodiments without materially departing from the novel teaching and advantages of this invention. Accordingly, all such modifications are intended to be included within the scope of this invention.

The present application claims priority under 35 U.S.C. section 119 to Japanese Patent Application No. 2009-180162 filed on Jul. 31, 2009.

The entire disclosure of Japanese Patent Application No. 2009-180162 filed on Jul. 31, 2009 including specification, claims, drawings and summary is incorporated herein by reference in its entirety.

What is claimed is:

1. An electric motor-driven brake apparatus comprising:
an electric motor; and
a rotation-rectilinear motion conversion mechanism converting rotation of the electric motor into a rectilinear motion to enable braking force to be generated;
the rotation-rectilinear motion conversion mechanism having a nut member driven to rotate by a rotor of the electric motor and a screw shaft disposed at an inner periphery of the nut member and moved rectilinearly by rotation of the nut member;
the nut member having a nut part engaged with the screw shaft and a rotor part axially extending from the nut part, the rotor of the electric motor being disposed at the rotor part of the rotation-rectilinear motion conversion mechanism.

2. The electric motor-driven brake apparatus of claim 1, wherein the rotor part is thinner in wall thickness than the nut part.

3. The electric motor-driven brake apparatus of claim 1, wherein the electric motor is an interior permanent magnet synchronous motor having a stator with windings.

4. The electric motor-driven brake apparatus of claim 3, wherein the rotor of the electric motor includes an annular rotor core and a permanent magnet inserted in each of a plurality of circumferentially equally spaced magnet insertion holes formed in the rotor core.

5. The electric motor-driven brake apparatus of claim 4, wherein an auxiliary magnetic pole is formed between each pair of mutually adjacent ones of the magnet insertion holes in the rotor core.

6. The electric motor-driven brake apparatus of claim 5, wherein a magnetic air gap is formed between the permanent magnet and the auxiliary magnetic pole.

7. The electric motor-driven brake apparatus of claim 4, wherein a bridge portion of small cross-sectional area is formed between each circumferential end of the permanent magnet and a stator-side end surface of the rotor core.

8. An electric motor-driven brake apparatus comprising:
an electric motor driven according to a driving command; and
a ball-screw mechanism converting rotation of the electric motor into a rectilinear motion to generate braking force;
the ball-screw mechanism having a circular cylindrical nut member driven to rotate by a rotor core of the electric motor and a screw shaft engaged with an inner peripheral portion of the nut member through rolling elements and moved rectilinearly by rotation of the nut member;
the nut member having a nut part engaged with the screw shaft and a rotor part axially extending from the nut part, the rotor core and the rotor part being connected to each other by press fitting.

9. The electric motor-driven brake apparatus of claim 8, wherein the rotor part is thinner in wall thickness than the nut part.

10. The electric motor-driven brake apparatus of claim 8, wherein the electric motor is an interior permanent magnet synchronous motor having a stator with windings.

11. The electric motor-driven brake apparatus of claim 10, wherein the electric motor includes a rotor having an annular rotor core and a permanent magnet inserted in each of a plurality of circumferentially equally spaced magnet insertion holes formed in the rotor core.

12. The electric motor-driven brake apparatus of claim 8, wherein the rotor part has a region to which the rotor core is secured and an end portion at a side of the rotor part remote from the nut part, the rotor part further having a small-diameter portion between the end portion and the region, the small-diameter portion being smaller in diameter than the region.

13. The electric motor-driven brake apparatus of claim 8, wherein an annular groove is formed between the nut part and a region of the rotor part to which the rotor core is secured.

14. The electric motor-driven brake apparatus of claim 8, wherein the rotor part has an axial recess-projection configuration formed on an inner peripheral surface thereof.

15. An electric motor-driven brake apparatus comprising:
a casing;
an electric motor provided in the casing and driven according to a driving command from a controller;
a rotation-rectilinear motion conversion mechanism supported by the casing and converting rotation of the electric motor into a rectilinear motion to propel a piston in a master cylinder; and
a rotation detector installed in the casing and detecting a rotational position of the electric motor;
the electric motor having a stator with windings and a rotor with permanent magnets;
the rotation-rectilinear motion conversion mechanism having a cylindrical rotating member driven to rotate by the rotor of the electric motor, and a rectilinearly moving shaft member engaged with an inner peripheral portion of the rotating member through rolling elements and moved rectilinearly by rotation of the rotating member;
the rotating member having an engaging part engaged with the rectilinearly moving shaft member and a rotor mounting part axially extending from the engaging part;
the rotor being secured to the rotor mounting part by press fitting.

16. The electric motor-driven brake apparatus of claim 15, wherein the casing comprises at least two axially separable members;
the stator being attached to one member of the at least two axially separable members, the rotation detector being attached to one other member of the at least two axially separable members;
the rotating member being rotatably supported at opposite ends thereof by the one member and the one other member, respectively.

17. The electric motor-driven brake apparatus of claim 15, wherein the rotor mounting part is thinner in wall thickness than the engaging part.

18. The electric motor-driven brake apparatus of claim 15, wherein the rotor mounting part has a small-diameter portion between a region of the rotor mounting part to which the rotor is secured and an end portion of the rotor mounting part at a side thereof remote from the engaging part, the small-diameter portion being smaller in diameter than the region.

19. The electric motor-driven brake apparatus of claim 15, wherein an annular groove is formed between the engaging part and a region of the rotor mounting part to which the rotor is secured.

20. The electric motor-driven brake apparatus of claim 15, wherein the rotor mounting part has an axial recess-projection configuration formed on an inner peripheral surface thereof.
